(19) United States
(12) Patent Application Publication
(10) Pub. No.: US 2007/0015879 A1
(43) Pub. Date: Jan. 18, 2007

(54) Highly-Neutralized Acid Polymer Compositions having a Low Moisture Vapor Transmission Rate and Their Use in Golf Balls

(76) Inventor: Michael J. Sullivan, Barrington, RI (US)

Correspondence Address: ACUSHNET COMPANY, 333 BRIDGE STREET, P. O. BOX 965, FAIRHAVEN, MA, 02719, US

(21) Appl. No.: 11/468,859

(22) Filed: Aug. 31, 2006

Related U.S. Application Data
(63) Continuation-in-part of application No. 11/270,066, filed on Nov. 9, 2005.
Application No. 11/270,066 is a continuation-in-part of application No. 10/959,751, filed on Oct. 6, 2004.
Application No. 10/959,751 is a continuation-in-part of application No. 10/360,233, filed on Feb. 6, 2003, now Pat. No. 6,939,907.
Application No. 10/360,233 is a continuation-in-part of application No. 10/118,719, filed on Apr. 9, 2002, now Pat. No. 6,756,436.
(60) Provisional application No. 60/301,046, filed on Jun. 26, 2001.

(51) Int. Cl. C08F 8/00; A63B 37/04; A63B 37/14

(52) U.S. Cl. 525/386; 473/371; 473/378

(57) ABSTRACT

The present invention is directed to golf balls having three or more cover layers, wherein at least one cover layer is formed from a moisture resistant composition. The moisture resistant composition has a moisture vapor transmission rate of 12.5 g·mil/100 in²/day or less and comprises a highly neutralized acid polymer.

### CROSS-REFERENCE TO RELATED APPLICATIONS

This application is a continuation-in-part of U.S. application Ser. No. 11/270,066, filed Nov. 9, 2005, which is a continuation-in-part of U.S. application Ser. No. 10/959,751, filed Oct. 6, 2004, which is a continuation-in-part of U.S. application Ser. No. 10/360,233, filed Feb. 6, 2003, now U.S. Pat. No. 6,939,907, which is a continuation-in-part of U.S. application Ser. No. 10/118,719, filed Apr. 9, 2002, now U.S. Pat. No. 6,756,436, which claims priority to U.S. Provisional Application No. 60/301,046, filed Jun. 26, 2001, the entire disclosures of which are hereby incorporated herein by reference.

### FIELD OF THE INVENTION

The present invention is directed to compositions having a moisture vapor transmission rate of 12.5 g·mil/100 in²/day or less and comprising a highly neutralized acid polymer. The present invention is also directed to the use of such compositions in golf equipment, and particularly in golf balls having three or more cover layers.

### BACKGROUND OF THE INVENTION

Highly neutralized acid polymers (“HNPs”) are a preferred group of polymers for golf ball layers, particularly cover layers, because of their toughness, durability, and wide range of hardness values. Conventional HNPs, however, are hydrophilic, due to the highly hydrophilic nature of the cation sources traditionally used to neutralize the ionomers, e.g., magnesium and magnesium salts of fatty acids. As a result of their hydrophilic nature, conventional HNPs can absorb a significant amount of moisture, e.g., 2,000 to 10,000 parts per million (ppm), which can result in processing difficulties, such as creating voids in the part during an injection molding process, and a reduction in golf ball performance, such as decreased coefficient of restitution (“COR”) over time and stiffness due to the plasticization of ionic aggregates by water molecules.

Thus, a desire remains in the golf ball industry for cover compositions having improved moisture vapor transmission properties. The present invention describes such compositions and the use thereof in golf balls, and particularly in golf balls having three or more cover layers.

### SUMMARY OF THE INVENTION

In one embodiment, the present invention is directed to a golf ball comprising a core and a cover. The core has an overall diameter of from 1.25 inches to 1.62 inches. The cover comprises an inner cover layer having a thickness of from 0.015 inches to 0.050 inches, an intermediate cover layer having a thickness of from 0.005 inches to 0.050 inches, and a polyurethane or polyurea outer cover layer having a thickness of from 0.001 inches to 0.050 inches. The inner cover layer is formed from a composition having a moisture vapor transmission rate of 12.5 g·mil/100 in²/day or less and comprising a highly neutralized polymer.

In another embodiment, the present invention is directed to a golf ball comprising a cover and a cover. The core has an overall diameter of from 1.25 inches to 1.62 inches. The cover comprises an inner cover layer having a thickness of from 0.015 inches to 0.050 inches, an intermediate cover layer having a thickness of from 0.005 inches to 0.050 inches, and a polyurethane or polyurea outer cover layer having thickness of from 0.001 inches to 0.050 inches. The intermediate cover layer is formed from a composition having a moisture vapor transmission rate of 12.5 g·mil/100 in²/day or less and comprising a highly neutralized polymer.

In another embodiment, the present invention is directed to a golf ball comprising a core and a cover. The core has an overall diameter of from 1.25 inches to 1.62 inches. The cover comprises an inner cover layer, an intermediate cover layer, and an outer cover layer. The inner cover layer has a thickness of from 0.015 inches to 0.050 and is formed from a first moisture resistant composition having a moisture vapor transmission rate of 12.5 g·mil/100 in²/day or less and comprising a first highly neutralized polymer. The intermediate cover layer has a thickness of from 0.005 inches to 0.050 inches and is formed from a second moisture resistant composition having a moisture vapor transmission rate of 12.5 g·mil/100 in²/day or less and comprising a second highly neutralized polymer. The outer cover layer has a thickness of from 0.001 inches to 0.050 inches and is formed from a polyurethane or polyurea composition.

### DETAILED DESCRIPTION OF THE INVENTION

Conventional golf balls can be divided into two general classes: solid and wound. Solid golf balls include one-piece, two-piece (i.e., solid core and a cover), and multi-layer (i.e., solid core of one or more layers and/or a cover of one or more layers) golf balls. Wound golf balls typically include a solid, hollow, or fluid-filled center, surrounded by a tensioned elastomeric material, and a cover.

Golf balls of the present invention include multi-layer and wound golf balls and comprise an inner cover layer, an intermediate cover layer, and an outer cover layer, at least one of which is formed from a moisture resistant composition. The layer formed from the moisture resistant composition can be the inner cover layer, the intermediate cover layer, the outer cover layer, or any combination of two or more thereof. Preferably, the inner cover layer and/or intermediate cover layer are formed from moisture resistant compositions.

For purposes of the present disclosure, a composition is “moisture resistant” if it has a moisture vapor transmission rate (“MVTR”) of 12.5 g·mil/100 in²/day or less. Preferably, the moisture resistant compositions of the present invention have an WTR of 8.0 g·mil/100 in²/day or less, or 6.5 g·mil/100 in²/day or less, or 5.0 g·mil/100 in²/day or less, or 4.0 g·mil/100 in²/day or less, or 2.5 g·mil/100 in²/day or less, or 2.0 g·mil/100 in²/day or less. As used herein, moisture vapor transmission rate (MVTR) is given in g·mil/100 in²/day, and is measured at 20° C., and according to ASTM F1249-99.

Moisture resistant compositions of the present invention comprise a highly neutralized acid polymer (“HNP”) and optionally one or more additional materials including, but not limited to, organic acids and salts thereof, fillers, additives, and non-fatty acid melt flow modifiers. In a preferred embodiment, the moisture resistant compositions consist essentially of an HNP and optionally one or more additional materials selected from the group consisting of organic acids and salts thereof, fillers, additives, and non-fatty acid melt flow modifiers. Consisting essentially of, as used herein, means that the recited components are essential, while smaller amounts of other components may be present to the extent that they do not detract from the operability of the present invention.

As used herein, “highly neutralized” refers to the acid polymer after at least 70%, preferably at least 80%, more preferably at least 90%, even more preferably at least 95%, and even more preferably 100%, of the acid groups thereof are neutralized. The HNP may be neutralized by a cation, a salt of an organic acid, a suitable base of an organic acid, or any combination of two or more thereof.

Suitable HNPs are salts of homopolymers and copolymers of α,β-ethylenically unsaturated mono- or dicarboxylic acids, and combinations thereof. The term “copolymer,” as used herein, includes polymers having two types of monomers, those having three types of monomers, and those having more than three types of monomers. Preferred acids are (meth) acrylic acid, ethacrylic acid, maleic acid, crotonic acid, famaric acid, itaconic acid. (Meth) acrylic acid is particularly preferred. As used herein, “(moth) acrylic acid” means methacrylic acid and/or acrylic acid. Likewise, “(meth) acrylate” means mothacrylate and/or acrylate. Preferred acid polymers are copolymers of a C₃ to C₈ α,β-ethylenically unsaturated mono- or dicarboxylic acid and ethylene or a C₃ to C₆ α-olefin, optionally including a softening monomer. Particularly preferred acid polymers are copolymers of ethylene and (moth) acrylic acid.

When a softening monomer is included, the acid polymer is referred to herein as an E/X/Y-type copolymer, wherein E is ethylene, X is a C₃ to C₈ α,β-ethylenically unsaturated mono- or dicarboxylic acid, and Y is a softening monomer. The softening monomer is typically an alkyl (moth) acrylate, wherein the alkyl groups have from 1 to 8 carbon atoms. Preferred E/X/Y-type copolymers are those wherein X is (meth) acrylic acid and/or Y is selected from (meth) acrylate, n-butyl (meth) acrylate, isobutyl (moth) acrylate, methyl (meth) acrylate, and ethyl (meth) acrylate. More preferred E/X/Y-type copolymers are ethylene/(meth) acrylic acid/n-butyl acrylate, ethylene/(meth) acrylic acid/methyl acrylate, and ethylene/(meth) acrylic acid/ethyl acrylate.

The amount of ethylene or C₃ to C₆ α-olefin in the acid copolymer is typically at least 15 wt %, preferably at least 25 wt %, more preferably at least 40 wt %, and even more preferably at least 60 wt %, based on the total weight of the copolymer. The amount of C₃ to C₈ α,β-ethylenically unsaturated mono- or dicarboxylic acid in the acid copolymer is typically within a range having a lower limit of 1 wt %, or 3 wt %, or 4 wt %, or 5 wt %, and an upper limit of 20 wt %, or 25 wt %, or 30 wt %, or 35 wt %, based on the total weight of the copolymer. The amount of optional softening comonomer in the acid copolymer is typically within a range having a lower limit of 0 wt %, or 5 wt %, 10 wt %, 15 wt %, and an upper limit of 20 wt %, or 30 wt %, or 35 wt %, or 40 wt %, or 50 wt %, based on the total weight of the copolymer.

The acid polymer may be partially neutralized prior to being neutralized to 70% and higher. Suitable partially neutralized acid polymers include, but are not limited to, Surlyn® ionomers, commercially available from E. I. du Pont de Nemours and Company; AClyn® ionomers, commercially available from Honeywell International Inc.; and Iotek® ionomers, commercially available from Exxornobil Chemical Company.

In a particular embodiment, the acid polymer is selected from Nucrel® acid copolymers, commercially available from E. I. du Pont de Nemours and Company (such as Nucrel®960, an ethylene/methacrylic acid copolymer); Primacor® polymers, commercially available from Dow Chemical Company (such as Primacor® XUS 60758.08L and XUS60751.18, ethylene/acrylic acid copolymers containing 13.5 wt % and 15.0 wt % acid, respectively); and partially neutralized ionomers thereof.

Additional suitable acid polymers are more fully described, for example, in U.S. Pat. No. 6,953,820 and U.S. Patent Application Publication No. 2005/0049367, the entire disclosures of which are hereby incorporated herein by reference.

The acid polymers of the present invention can be direct copolymers wherein the polymer is polymerized by adding all monomers simultaneously, as described in, for example, U.S. Pat. No. 4,351,931, the entire disclosure of which is hereby incorporated herein by reference. Tonomers can be made from direct copolymers, as described in, for example, U.S. Pat. No. 3,264,272 to Rees, the entire disclosure of which is hereby incorporated herein by reference. Alternatively, the acid polymers of the present invention can be graft copolymers wherein a monomer is grafted onto an existing polymer, as described in, for example, U.S. Patent Application Publication No. 2002/0013413, the entire disclosure of which is hereby incorporated herein by reference.

Cations suitable for neutralizing the acid polymers of the present invention are selected from silicone, silane, and silicate derivatives and complex ligands; metal ions and compounds of rare earth elements; metal ions and compounds of alkali metals, alkaline earth metals, and transition metals; and combinations thereof. Particular cation sources include, but are not limited to, metal ions and compounds of lithium, sodium, potassium, magnesium, cesium, calcium, barium, manganese, copper, zinc, tin, rare earth metals, and combinations thereof. In a particular embodiment, the cation source is selected from metal ions and compounds of calcium, metal ions and compounds of zinc, and combinations thereof In a particular aspect of this embodiment, the equivalent percentage of calcium and/or zinc salt(s) in the final composition is 50% or higher, or 60% or higher, or 70% or higher, or 80% or higher, or 90% or higher, based on the total salts present in the final composition, wherein the equivalent % is determined by multiplying the mol% of the cation by the valence of the cation. In another particular embodiment, the cation source is selected from metal ions and compounds of lithium, sodium, potassium, magnesium, calcium, zinc, and combinations thereof. A particular potassium-based cation source is Oxone®, commercially available from E. I. du Pont de Nemours and Company. Oxone® is a monopersulfate compound wherein potassium monopersulfate is the active ingredient present as a component of a triple salt of the formula 2KHSO₅.KHSO₄.K₂SO₄ [potassium hydrogen peroxymonosulfate sulfate (5:3:2:2)]. In another particular embodiment, the cation source is selected from metal ions and compounds of lithium, metal ions and compounds of zinc, and combinations thereof. Suitable cation sources also include mixtures of lithium and/or zinc cations with other cations. Other cations suitable for mixing with lithium and/or zinc cations to produce the HNP include, but are not limited to, the “less hydrophilic” cations disclosed in U.S. Patent Application Publication No. 2006/0106175; conventional HNP cations, such as those disclosed in U.S. Pat. Nos. 6,756,436 and 6,824,477; and the cations disclosed in U.S. Patent Application Publication No. 2005/026740. The entire disclosure of each of these references is hereby incorporated herein by reference. In a particular aspect of this embodiment, the percentage of lithium and/or zinc salts in the composition is preferably 50% or higher, or 55% or higher, or 60% or higher, or 65% or higher, or 70% or higher, or 80% or higher, or 90% or higher, or 95% or higher, or 100%, based on the total salts present in the composition. The amount of cation source used is readily determined based on the desired level of neutralization.

Moisture resistant compositions of the present invention optionally comprise one or more organic acids and/or salts thereof. Suitable organic acids are aliphatic organic acids, aromatic organic acids, saturated monofu-nctional organic acids, unsaturated monofunctional organic acids, multiunsaturated monofunctional organic acids, and dimerized derivatives thereof. Particularly suitable are aliphatic, monofinctional organic acids, preferably having fewer than 36 carbon atoms. Particular examples of suitable organic acids include, but are not limited to, caproic acid, caprylic acid, capric acid, lauric acid, stearic acid, behenic acid, erucic acid, oleic acid, linoleic acid, myristic acid, benzoic acid, palmitic acid, phenylacetic acid, naphthalenoic acid, and dimerized derivatives thereof Particularly suitable organic acid salts include those produced by a cation source selected from barium, lithium, sodium, zinc, bismuth, potassium, strontium, magnesium, calcium, and combinations thereof. Suitable organic acids are more fully described, for example, in U.S. Patent No. 6,756,436, the entire disclosure of which is hereby incorporated herein by reference.

Moisture resistant compositions of the present invention optionally contain one or more additives and/or one or more fillers. Suitable additives include, but are not limited to, blowing and foaming agents, optical brighteners, coloring agents, fluorescent agents, whitening agents, UV absorbers, light stabilizers, defoaming agents, processing aids, mica, talc, nanofillers, antioxidants, stabilizers, softening agents, fragrance components, plasticizers, impact modifiers, acid copolymer wax, and surfactants. Suitable fillers include, but are not limited to, inorganic fillers, such as zinc oxide, titanium dioxide, tin oxide, calcium oxide, magnesium oxide, barium sulfate, zinc sulfate, calcium carbonate, zinc carbonate, barium carbonate, mica, talc, clay, silica, lead silicate, and the like; high specific gravity metal powder fillers, such as tungsten powder, molybdenum powder, and the like; regrind, i.e., core material that is ground and recycled; and nano-fillers. Filler materials may be dual-functional fillers, for example, zinc oxide (which may be used as a filler/acid scavenger) and titanium dioxide (which may be used as a filler/brightener material). Further examples of suitable fillers and additives include, but are not limited to, those disclosed in U.S. Patent Application Publication No. 2003/0225197, the entire disclosure of which is hereby incorporated herein by reference.

Moisture resistant compositions of the present invention optionally contain one or more non-fatty acid melt flow modifiers. Suitable non-fatty acid melt flow modifiers include polyamides, polyesters, polyacrylates, polyurethanes, polyethers, polyureas, polyhydric alcohols; and combinations thereof. Additional melt flow modifiers, suitable for use in compositions of the present invention, include those described in copending U.S. Patent Application Publication No. 2006/0063893 and U.S. patent application Ser. No. 11/216,726, the entire disclosures of which are hereby incorporated herein by reference.

Moisture resistant compositions of the present invention are optionally produced by blending the HNP with one or more additional polymers, such as thermoplastic polymers and elastomers. Examples of thermoplastic polymers suitable for blending with the invention HNPs include, but are not limited to, polyolefins, polyamides, polyesters, polyethers, polyether-esters, polyether-amides, polyether-urea, polycarbonates, polysulfones, polyacetals, polylactones, acrylonitrile-butadiene-styrene resins, polyphenylene oxide, polyphenylene sulfide, styrene-acrylonitrile resins, styrene maleic anhydride, polyimides, aromatic polyketones, ionomers and ionomeric precursors, acid homopolymers and copolymers, conventional ionomers and HNPs (e.g., ionomeric materials sold under the trade names :DuPont® HPF 1000 and DuPont® HPF 2000, commercially available from E. I. du Pont de Nemours and Company), rosin-modified ionomers, bimodal ionomers, polyurethanes, grafted and non-grafted metallocene-catalyzed polymers, single-site catalyst polymerized polymers, high crystalline acid polymers, cationic ionomers, epoxy-functionalized polymers, anhydride-functionalized polymers, and combinations thereof. Particular polyolefins suitable for blending include one or more, linear, branched, or cyclic, C₂-C₄₀ olefins, particularly polymers comprising ethylene or propylene copolymerized with one or more C₂-C₄₀ olefins, C₃-C₂₀ α-olefins, or C₃-C₁₀ α-olefins. Particular conventional HNPs suitable for blending include, but are not limited to, one or more of the HNPs disclosed in U.S. Pat. Nos. 6,756,436, 6,894,098, and 6,953,820, the entire disclosures of which are hereby incorporated herein by reference. Examples of elastomers suitable for blending with the invention polymers include natural and synthetic rubbers, including, but not limited to, ethylene propylene rubber (“EPR”), ethylene propylene diene rubber (“EPDM”), hydrogenated and non-hydrogenated styrenic block copolymer rubbers (such as SI, SIS, SB, SBS, SIBS, and the like, where “S” is styrene, “I” is isobutylene, and “Be is butadiene), butyl rubber, halobutyl rubber, copolymers of isobutylene and para-alkylstyrene, halogenated copolymers of isobutylene and para-alkylstyrene, natural rubber, polyisoprene, copolymers of butadiene with acrylonitrile, polychloroprene, alkyl acrylate rubber, chlorinated isoprene rubber, acrylonitrile chlorinated isoprene rubber, polybutadiene rubber, and thermoplastic vulcanizates. Additional suitable blend polymers include those described in U.S. Pat. No. 5,981,658, for example at column 14, lines 30 to 56, and in U.S. Patent Application Publication No. 2005/0267240, for example at paragraph [0073], the entire disclosures of which are hereby incorporated herein by reference. The blends described herein may be produced by post-reactor blending, by connecting reactors in series to make reactor blends, or by using more than one catalyst in the same reactor to produce multiple species of polymer. The polymers may be mixed prior to being put into an extruder, or they may be mixed in an extruder.

The present invention is not limited by any particular method or any particular equipment for making the moisture resistant composition. In a preferred embodiment, the composition is prepared by the following process. An acid polymer, preferably ethylene/(meth) acrylic acid, and at least one organic acid or salt thereof, and optional additional materials, such as additive(s), filler(s), and non-fatty acid melt flow modifier(s), are fed into a melt extruder, such as a single or twin screw extruder A suitable amount of a cation source, preferably calcium- and/or zinc-based, is added to the molten acid polymer composition such that at least 70% of all acid groups present are neutralized, including the acid groups of the acid polymer and the acid groups of the optional organic acid. Preferably at least 80%, more preferably at least 90%, more preferably at least 95%, and even more preferably at least 100%, of all acid groups present are neutralized. The acid polymer may be partially neutralized prior to contact with the cation source, preferably with a cation source selected from metal ions and compounds of calcium, magnesium, and zinc. The acid polymer/cation mixture is intensively mixed prior to being extruded as a strand from the die-head. In a particular aspect of this embodiment, the acid polymer is an ethylene/(meth) acrylic acid polymer selected from Nucrel® acid copolymers, commercially available from E. I. du Pont de Nemours and Company (such as Nucrel® 960, an ethylene/methacrylic acid copolymer) and Primacor® polymers, commercially available from Dow Chemical Company (such as Primacor® XUS 60758.08L and XUS60751.18, ethylene/acrylic acid copolymers containing 13.5 wt % and 15.0 wt % acid, respectively).

Further examples of suitable moisture resistant compositions include, but are not limited to, compositions containing an HNP neutralized by a less hydrophilic cation source as disclosed in U.S. Patent Application Publication No. 2006/0106175, the entire disclosure of which is hereby incorporated herein by reference.

Moisture resistant compositions of the present invention typically have a flexural modulus of from 1,000 psi to 150,000 psi. The material hardness of the composition is generally from 10 Shore D to 85 Shore D. The notched izod impact strength of the moisture resistant compositions of the present invention is generally at least 2 ft-lb/in, as measured at 23° C. according to ASTM D256.

Moisture resistant compositions of the present invention generally have a melt flow index of at least 0.1 g/10 min (190° C., 2.16 kg). Preferably, the melt flow index of the moisture resistant composition is at least 0.5 g/10 min, or within the range having a lower limit of 0.5, or 0.8, or 1.0, and an upper limit of 4.0, or 5.0, or 10.0, or 20.0 g/10 min. For purposes of the present disclosure, melt flow index is measured according to ASTM D1238.

Moisture resistant compositions of the present invention can be used in a variety of applications. For example, moisture resistant compositions containing HNPs are suitable for use in golf equipment, including, but not limited to, golf balls, golf shoes, and golf clubs. By the present invention, it has been found that the moisture resistant compositions described herein are particularly suitable for forming one or more cover layers of golf balls having three or more cover layers.

Golf balls of the present invention can be wound or multi-layer balls, and have at least one cover layer which is formed from a moisture resistant composition described herein. In golf balls having two or more cover layers which comprise a moisture resistant composition, the moisture resistant composition of one cover layer may be the same or a different moisture resistant composition as another cover layer. Compositions of the present invention can be either foamed or filled with density adjusting materials to provide golf balls having modified moments of inertia.

Golf ball covers of the present invention comprise an inner cover layer, an intermediate cover layer, and an outer cover layer, one or more of which is formed from a moisture resistant composition described herein. The inner cover layer preferably has a thickness of 0.03 inches or a thickness within the range having a lower limit of 0.010 or 0.015 inches and an upper limit of 0.050 inches. The intermediate cover layer preferably has thickness of 0.015 inches or a thickness within the range having a lower limit of 0.005 or 0.010 inches and an upper limit of 0.050 or 0.020 inches. The outer cover layer preferably has a thickness within the range having a lower limit of 0.001 or 0.005 or 0.010 inches and an upper limit of 0.030 or 0.035 or 0.050 inches.

Golf ball cores of the present invention may consist of a single, unitary layer, comprising the entire core from the center of the core to its outer periphery, or they may consist of a center surrounded by one or more outer core layers. The center, innermost portion of the core is preferably solid, but may be hollow or liquid-, gel-, or gas-filled. The outer core layer may be solid, or it may be a wound layer formed of a tensioned elastomeric material. The overall core diameter is preferably within the range having a lower limit of 1.25 or 1.40 inches and an upper limit of 1.60 or 1.62 inches.

Golf balls of the present invention generally have a coefficient of restitution (“COR”) of at least 0.790, preferably at least 0.800, more preferably at least 0.805, and even more preferably at least 0.810, and compression of from 75 to 110, preferably from 90 to 100.

The present invention is not limited by any particular process for forming the golf ball layer(s). It should be understood that the layer(s) can be formed by any suitable technique, including injection molding, compression molding, casting, and reaction injection molding.

Preferably, thermoset cover materials are formed into golf ball cover layers by casting or reaction injection molding and thermoplastic cover materials are formed into golf ball cover layers by compression or injection molding techniques.

In a preferred embodiment, the present invention provides a golf ball comprising a core, an inner cover layer, an intermediate cover layer, and an outer cover layer, wherein the inner cover layer is formed from a moisture resistant composition described herein. The moisture resistant composition comprises an HNP and has an MVTR of 12.5 g·mil/100 in²/day or less, preferably 8.0 or less, more preferably 6.5 or less, even more preferably 5.0 or less, even more preferably 4.0 or less, even more preferably 2.5 or less, and most preferably 2.0 or less. Preferably, at least 80%, or at least 90%, or at least 95%, or 100%, of all acid functionalities present in the moisture resistant composition are neutralized. In a particular aspect of this embodiment, the core is a solid, single layer core. In another particular aspect of this embodiment, the core is a dual- or multi-layer core.

In another preferred embodiment, the present invention provides a golf ball comprising a core, an inner cover layer, an intermediate cover layer, and an outer cover layer, wherein the intermediate cover layer is formed from a moisture resistant composition described herein. The moisture resistant composition comprises an HNP and has an MVTR of 12.5 g·mil/100 in²/day or less, preferably 8.0 or less, more preferably 6.5 or less, even more preferably 5.0 or less, even more preferably 4.0 or less, even more preferably 2.5 or less, and most preferably 2.0 or less. Preferably, at least 80%, or at least 90%, or at least 95%, or 100%, of all acid fuinctionalities present in the moisture resistant composition are neutralized. In a particular aspect of this embodiment, the core is a solid, single layer core. In another particular aspect of this embodiment, the core is a dual- or multi-layer core.

In another preferred embodiment, the present invention provides a golf ball comprising a core, an inner cover layer, an intermediate cover layer, and an outer cover layer, wherein the inner cover layer and the intermediate cover layer are formed from a moisture resistant composition described herein. The moisture resistant composition of the inner cover layer may be the same as or different than the moisture resistant composition of the intermediate cover layer. The moisture resistant composition comprises an HNP and has an MVTR of 12.5 g·mil/100 in²/day or less, preferably 8.0 or less, more preferably 6.5 or less, even more preferably 5.0 or less, even more preferably 4.0 or less, even more preferably 2.5 or less, and most preferably 2.0 or less. Preferably, at least 80%, or at least 90%, or at least 95%, or 100%, of all acid finctionalities present in the moisture resistant composition are neutralized. In a particular aspect of this embodiment, the core is a solid, single layer core. In another particular aspect of this embodiment, the core is a dual- or multi-layer core.

Golf balls of the present invention may have at least one layer formed from a composition other than the moisture resistant composition disclosed above. Suitable materials for golf ball core, intermediate and cover layers of the present invention include, but are not limited to, polyethylene, including, for example, low density polyethylene, linear low density polyethylene, and high density polyethylene; polypropylene; rubber-toughened olefin polymers; copolyether-esters; copolyether-amides; polycarbonates; acid copolymers which do not become part of an ionomeric copolymer; plastomers; flexomers; vinyl resins, such as those formed by the copolymerization of vinyl chloride with vinyl acetate, acrylic esters or vinylidene chloride; styrenelbutadiene/styrene block copolymers; styrene/ethylene-butylene/styrene block copolymers; dynamically vulcanized elastomers; ethylene vinyl acetates; ethylene methacrylates and ethylene ethacrylates; ethylene methacrylic acid, ethylene acrylic acid, and propylene acrylic acid; polyvinyl chloride resins; copolymers and homopolymers produced using a metallocene or other single-site catalyst; polyamides, amide-ester elastomers, and graft copolymers of ionomer and polyamide, including, for example, Pebax® thermoplastic polyether block amides, commercially available from Arkema Inc; polyphenylene oxide resins or blends of polyphenylene oxide with high impact polystyrene, such as NORYL®, commercially available by General Electric Company of Pittsfield, Mass.; crosslinked transpolyisoprene blends; polyurethanes; polyureas; polyester-based thermoplastic elastomers, such as Hytrel®, commercially available from E. I. du Pont de Nemours and Company, and LOMOD®, commercially available from General Electric Company; polyurethane-based thermoplastic elastomers, such as Elastollan®, commercially available from BASF; natural and synthetic rubbers; partially and fully neutralized ionomers; and combinations thereof Suitable golf ball materials and constructions also include, but are not limited to, those disclosed in U.S. Pat. Nos. 5,919,100, 6,117,025, 6,767,940, and 6,960,630, the entire disclosures of which are hereby incorporated herein by reference.

Polybutadiene is a preferred material for forming the core of golf balls of the present invention.

Particularly preferred materials for forming the outer cover layer of golf balls of the present invention include, but are not limited to, polyurethanes, polyureas, copolymers thereof, polyurethane-ionomer copolymers, and blends thereof in an interpenetrating polymer network. Such materials are also suitable for forming inner and intermediate cover layers and are further disclosed, for example, in U.S. Patent Application Publication Nos. 2004/0235587, and 2004/0010096, the entire disclosures of which are hereby incorporated herein by reference.

In addition to the moisture resistant compositions described herein, particularly preferred materials for forming the inner cover layer and intermediate cover layer of golf balls of the present invention include, but are not limited to, partially, highly, and filly neutralized ionomers, including, for example, Surlyn® ionomers, commercially available from E. I. du Pont de Nemours and Company, and Iotek® and Escor® ionomers, commercially available from ExxonMobil Chemical Company; polyamides; non-ionomeric polyolefins; metallocene-catalyzed polymers; Fusabond® functionalized polymers, commercially available from E. I. du Pont de Nemours and Company; polycarbonates; styrene-butadiene block copolymers; amide-ester elastomers; polyesters; and blends thereof. Additional materials suitable for forming the inner and intermediate cover layers include, but are not limited to, those disclosed in U.S. Patent Application Publication No. 2004/0235587, the entire disclosure of which is hereby incorporated herein by reference.

For purposes of the present invention, compression is measured according to a known procedure, using an Atti compression test device, wherein a piston is used to compress a ball against a spring. The travel of the piston is fixed and the deflection of the spring is measured. The measurement of the deflection of the spring does not begin with its contact with the ball; rather, there is an offset of approximately the first 1.25 mm (0.05 inches) of the spring's deflection. Very low stiffness cores will not cause the spring to deflect by more than 1.25 mm and therefore have a zero compression measurement. The Atti compression tester is designed to measure objects having a diameter of 42.7 mm (1.68 inches); thus, smaller objects, such as golf ball cores, must be shimmed to a total height of 42.7 mm to obtain an accurate reading.

For purposes of the present invention, COR is determined according to a known procedure wherein a golf ball or golf ball subassembly (e.g., a golf ball core) is fired from an air cannon at a given velocity (125 ft/s for purposes of the present invention). Ballistic light screens are located between the air cannon and the steel plate to measure ball velocity. As the ball travels toward the steel plate, it activates each light screen, and the time at each light screen is measured. This provides an incoming transit time period inversely proportional to the ball's incoming velocity. The ball impacts the steel plate and rebounds though the light screens, which again measure the time period required to transit between the light screens. This provides an outgoing transit time period inversely proportional to the ball's outgoing velocity. COR is then calculated as the ratio of the incoming transit time period to the outgoing transit time period, COR=Tᵢₙ/Tₒᵤₜ.

When numerical lower limits and numerical upper limits are set forth herein, it is contemplated that any combination of these values may be used.

All patents, publications, test procedures, and other references cited herein, including priority documents, are fully incorporated by reference to the extent such disclosure is not inconsistent with this invention and for all jurisdictions in which such incorporation is permitted while the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

What is claimed is:

1. A golf ball comprising:
a core having an overall diameter of from 1.25 inches to 1.62 inches;
a cover comprising:
an inner cover layer having a thickness of from 0.015 inches to 0.050 inches;
a polyurethane or polyurea outer cover layer having a thickness of from 0.001 inches to 0.050 inches; and
an intermediate cover layer disposed between the inner cover layer and outer cover layer and having a thickness of from 0.005 inches to 0.050 inches;
wherein the inner cover layer is formed from a moisture resistant composition, the moisture resistant composition having a moisture vapor transmission rate (MVTR) of 12.5 g·mil/100 in²/day or less and comprising a highly neutralized acid polymer.

2. The golf ball of claim 1, wherein 80% or more of the acid groups present in the moisture resistant composition are neutralized to salts.

3. The golf ball of claim 2, wherein 50% or more of the acid groups present in the moisture resistant composition are neutralized to salts having counterions selected from the group consisting of Zn, Ca, and combinations thereof.

4. The golf ball of claim 1, wherein 70% or more of the acid groups present in the moisture resistant composition are neutralized to salts having counterions selected from the group consisting of Zn, Ca, and combinations thereof.

5. The golf ball of claim 1, wherein the moisture resistant composition has an MVTR of 4.0 g·mil/100 in²/day or less.

6. The golf ball of claim 1, wherein the moisture resistant composition has an MVTR of 2.5 g·mil/100 in²/day or less.

7. The golf ball of claim 6, wherein 100% of the acid groups present in the moisture resistant composition are neutralized.

8. The golf ball of claim 1, wherein the intermediate cover layer is formed from the same or a different moisture resistant composition as the inner cover layer.

9. A golf ball comprising:
a core having an overall diameter of from 1.25 inches to 1.62 inches;
a cover comprising:
an inner cover layer having a thickness of from 0.015 inches to 0.050 inches;
a polyurethane or polyarea outer cover layer having a thickness of from 0.001 inches to 0.050 inches; and
an intermediate cover layer disposed between the inner cover layer and outer cover layer and having a thickness of from 0.005 inches to 0.050 inches;
wherein the intermediate cover layer is formed from a moisture resistant composition, the moisture resistant composition having a moisture vapor transmission rate (MVTR) of 12.5 g·mil/100 in²/day or less and comprising a highly neutralized acid polymer.

10. The golf ball of claim 9, wherein 80% or more of the acid groups present in the moisture resistant composition are neutralized to salts.

11. The golf ball of claim 10, wherein 50% or more of the acid groups present in the moisture resistant composition are neutralized to salts having counterions selected from the group consisting of Zn, Ca, and combinations thereof.

12. The golf ball of claim 9, wherein 70% or more of the acid groups present in the moisture resistant composition are neutralized to salts having counterions selected from the group consisting of Zn, Ca, and combinations thereof.

13. The golf ball of claim 9, wherein the moisture resistant composition has an MVTR of 4.0 g·mil/100 in²/day or less.

14. The golf ball of claim 9, wherein the moisture resistant composition has an MVTR of 2.5 g·mil/100 in²/day or less.

15. The golf ball of claim 14, wherein 100% of the acid groups present in the moisture resistant composition are neutralized.

16. The golf ball of claim 9, wherein the intermediate cover layer is formed from the same or a different moisture resistant composition as the inner cover layer.

17. A golf ball comprising:
a core having an overall diameter of from 1.25 inches to 1.62 inches;
a cover comprising:
an inner cover layer having a thickness of from 0.015 inches to 0.050 inches and formed from a first moisture resistant composition, the first moisture resistant composition having a moisture vapor transmission rate (MVTR) of 12.5 g·mil/100 in²/day or less and comprising a first highly neutralized acid polymer;
a polyurethane or polyurea outer cover layer having a thickness of from 0.001 inches to 0.050 inches; and
an intermediate cover layer disposed between the inner cover layer and outer cover layer, the intermediate cover layer having a thickness of from 0.005 inches to 0.050 inches and formed from a second moisture resistant composition, the second moisture resistant composition having a moisture vapor transmission rate (NVTR) of 12.5 g·mil/100 in²/day or less and comprising a second highly neutralized acid polymer.
